(19) United States
(12) Patent Application Publication
(10) Pub. No.: US 2019/0012882 A1
(43) Pub. Date: Jan. 10, 2019

(54) UI/UX4SSM

(71) Applicant: Randol Poueriet, Bronx, NY (US)

(72) Inventor: Randol Poueriet, Bronx, NY (US)

(21) Appl. No.: 16/028,405

(22) Filed: Jul. 5, 2018

Related U.S. Application Data
(60) Provisional application No. 62/633,074, filed on Feb. 21, 2018.
(60) Provisional application No. 62/528,881, filed on Jul. 5, 2017.

(51) Int. Cl. G07F 19/00; G06Q 40/02; G06F 3/0484; G06F 3/0481

(52) U.S. Cl. CPC G07F 19/206; G06F 3/04817; G06F 3/04842; G06Q 40/02

(57) ABSTRACT

The present disclosure relates to electronic devices. More particularly, the present disclosure describes a minimalist user interface/user experience (UI/UX) concept design for ATMs, Vending Machines and other self-service machines. This is Ul/UX concept does not requires the customer to progress through a series of interfaces to submit an order. This is a single faceted user interface where all the sections necessary to submit an order are organized into Rows.

Some Rows feature a set of buttons as options for the customer to select the desired one in each Row, some Rows may feature a pre-selected Option. These buttons feature radio button functionality which makes the button selected by the user stay highlighted making it easier for the user to, with a quick glance, identify the item he has selected at each row and also verify his order before submitting it. Some Rows may feature a number keypad or decrement an increment buttons which the user will use to specify the desired quantity of a selected item/service.

This IP also discloses several configurations for some rows (sections) that make this Ul/UX concept suited for either ATMs or Vending Machines.

### BACKGROUND

With the rapid digitalization that is currently taking place in the world self-service is becoming the norm. Banks, metro stations, retail stores and others are deploying state of the art self-service machines where customers self-assist them selves. The issue with all these fancy machines is that although hardware is very advanced the user experience (UX) is not very friendly.

The main problem with the User interface/user experience (UI/UX) in ATMs and vending machines is that they require customers to progress through a series of interfaces to submit an order. Its not a secret everyone dislikes having got progress though a series of interfaces to submit an order at ATMs and vending machines. This experience overwhelms users, causes long wait lines during hours of high demand.

The current User interface/user experience (UI/UX) design in ATMs and vending machines consumes unnecessary time from users. A problem with this multifaceted User Experience is that if the user miss-selects the desired option he will then have to navigate backwards in order to make a correction to then come forward again.

Another problem with the UI/UX design in machines is that some of them are too fancy and futuristic appealing in effort to impress the user but they confuse or distract them instead. Users who are not tech-savvy struggle with these types of designs. These type of designs are not user friendly.

At Metro stations is actually much easier and faster to buy a Metro pass via the Teller in the Station then via the Vending Machine.

It is not a pleasant customer experience to: Select a Language in order to progress to the next interface, Select a desired service in order to progress to the following interface, Select an Account for the Transaction in order to progress to the following interface and more. This same overwhelming experience exists at Vending machines. The current multi-faceted UI/UX design in self-service machines today is not pleasant at all. This results in unnecessary time consumption because customers spend some time identifying the purpose of each interface they are presented with and selecting their desired option.

Some UI/UX designs in an effort to offer a minimalist experience they end up offering an incomplete design and experience.

Many UI/UX design feature too much variety and inconsistency, the step required to submit an order are completely different even when ordering the service but with different amount. For example the steps required to make a $40 withdraw at an ATM is completely different from the steps required to withdraw $750 at that same ATM machine.

The current UI/UX designs in ATMs and vending machines have many flaws: they are either complete but not minimalist, minimalist but not complete, Too modern or too obsolete, inconsistent, confuse the customer, require the customer to make unnecessary things such as making them select the native language of their own country.

These are serious flaws because the UI/UX design in ATMs and other self-service machines is responsible of ensuring a pleasant customer experience at the machine. Because of this flaws many customers need to learn how to use a simple machine. These flaws scare customers and makes them want to avoid using the machine.

### BRIEF DESCRIPTION OF THE DRAWINGS

This IP discloses a single faceted user interface/user experience UI/UX concept for self-service machines such as ATM and vending machines. In this concept sections necessary for the customer to submit his order are organized into rows each featuring a set of option for the customer to select the desired one. Several configurations for these rows are also presented, this configuration make this design suited for either ATMs or Vending machines.

FIG. 1A illustrates the mentioned UI/UX concept being disclosed in this IP. The model in in this illustration is a customized model for ATM machines (automated teller machines).

FIG. 1B illustrates the model in FIG. 1A with some options selected by the user in each Row. The radio button functionality can appreciated in this illustration. Also the number keypad was used to input desired amount.

FIG. 1B illustrates the content of a Row before being replaced after a button is tapped by the user. FIG. 1C illustrates the content of the Row after it was replaced as a result of a button being tapped.

FIG. 1D illustrates two buttons selected. FIG. 1E illustrates a prompting panel being displayed as a result of those selected buttons

FIG. 1F illustrates a dropdown-menu in a Row displaying its option for the user to select the desired one.

FIG. 1G illustrates an option of the mentioned dropdown menu has been being selected by the user.

FIG. 1H illustrates an arrow pointing from the button representing an account to the button representing the other account signaling the source and destination account for the transfer.

FIG. 1i illustrates also an option being selected from the mentioned dropdown-menu.

FIG. 1J illustrates a panel prompting the user user to input data at two empty slots.

FIG. 1K illustrates a button taped by the user and FIG. 1L displays a prompting panel asking the user to make a final selection.

FIG. 1M illustrates the content of two Rows before they get replaced as a result of of button tapped by the user. FIG. 1N displays the new content of those two rows after the user tapped the button.

FIG. 10 illustrates the concept of two Rows (sections) combined into a single Row. This is a customized version ATM machines.

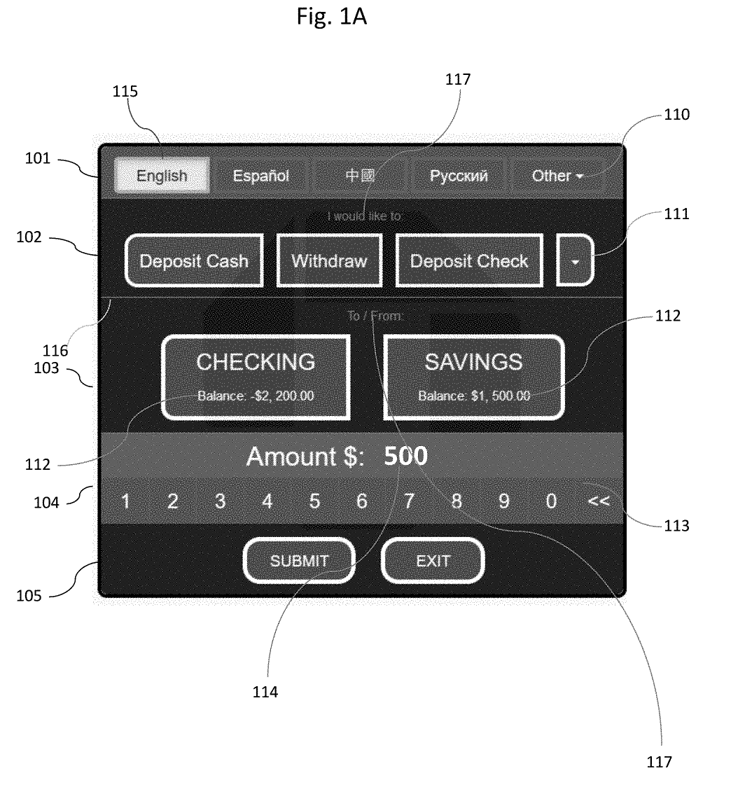

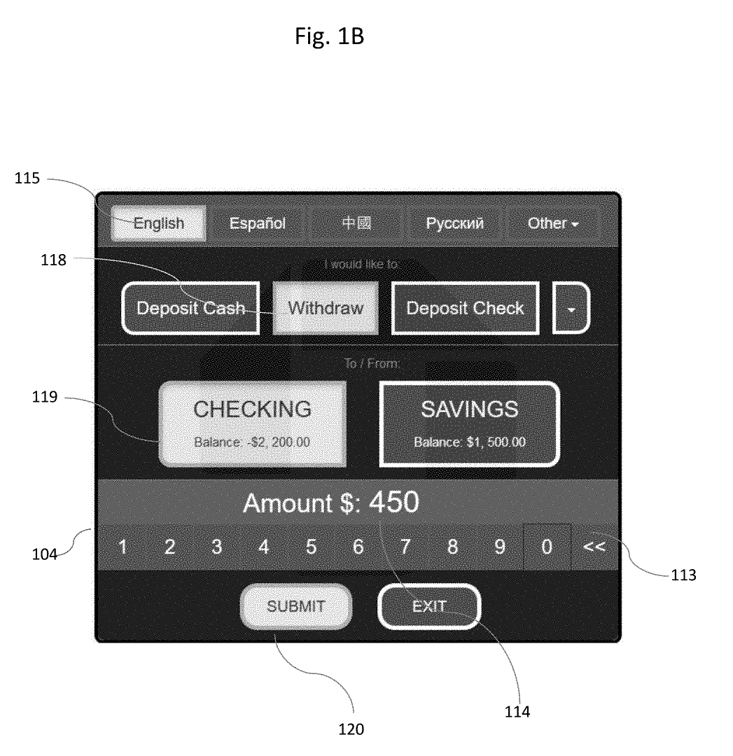

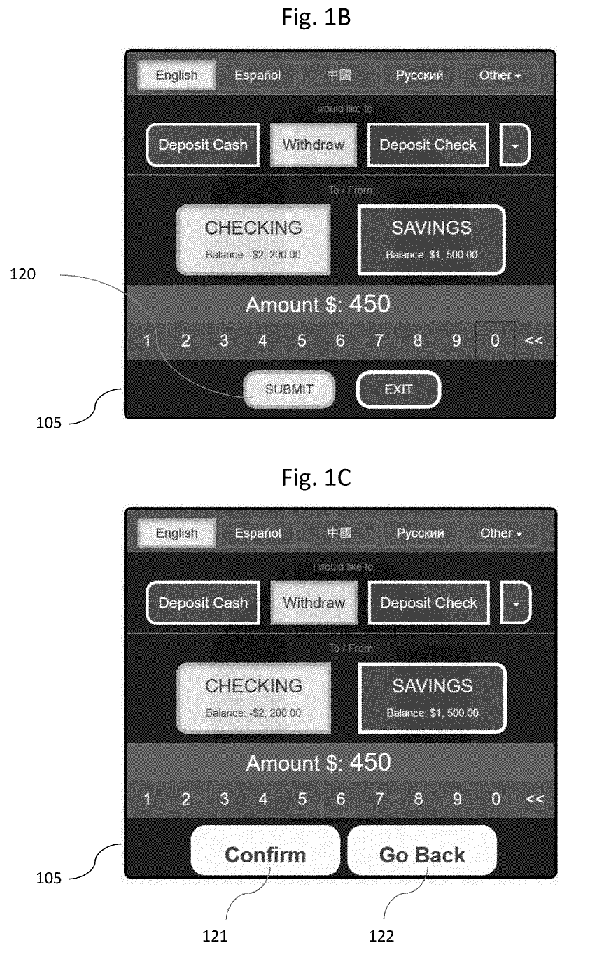

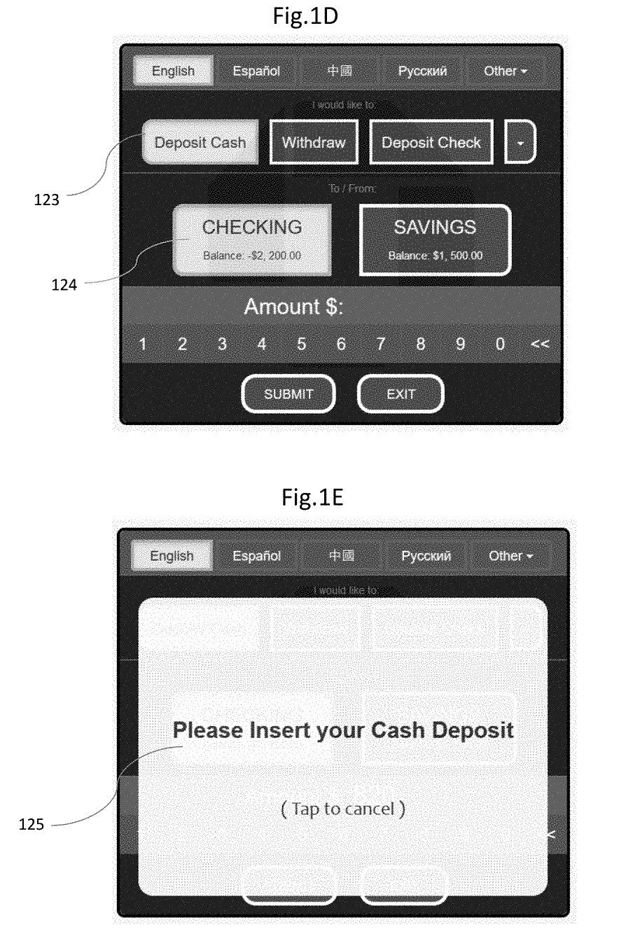

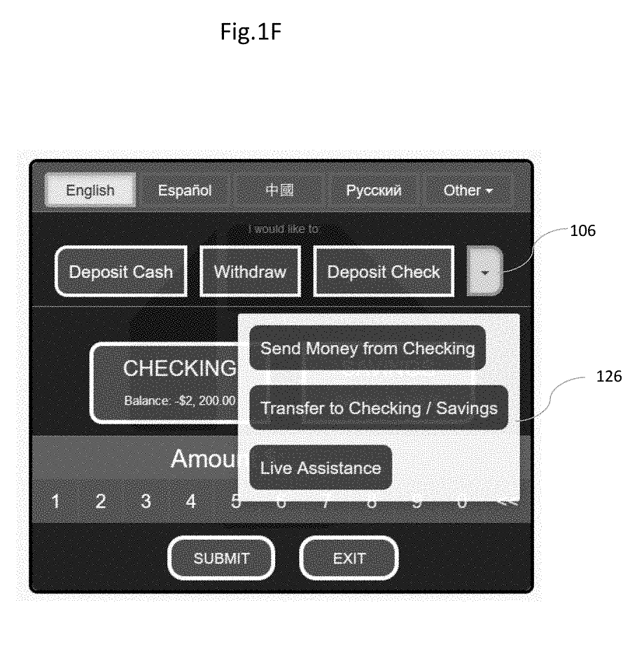

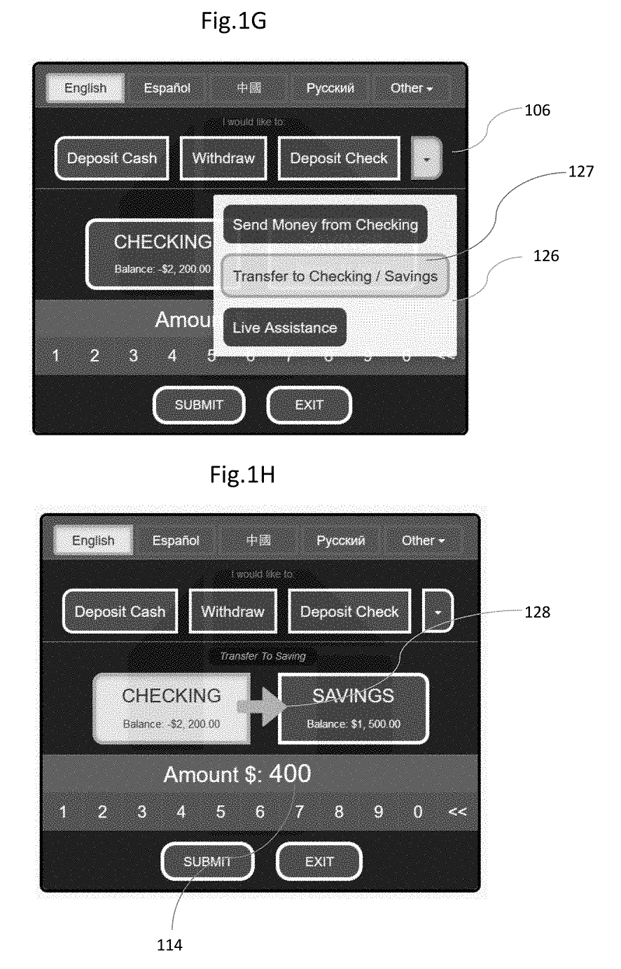

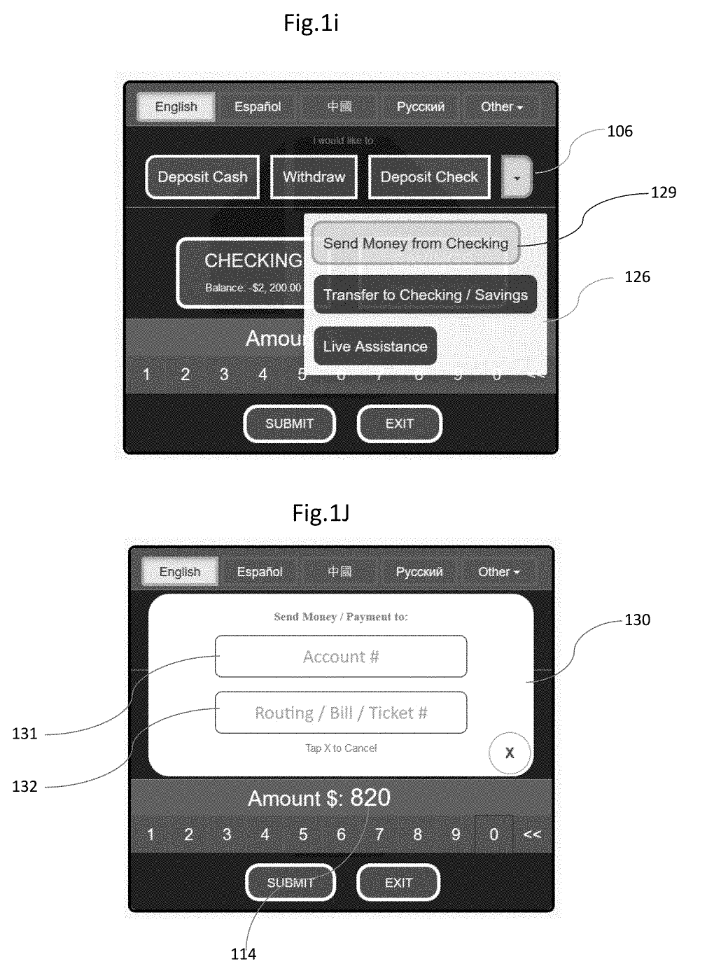

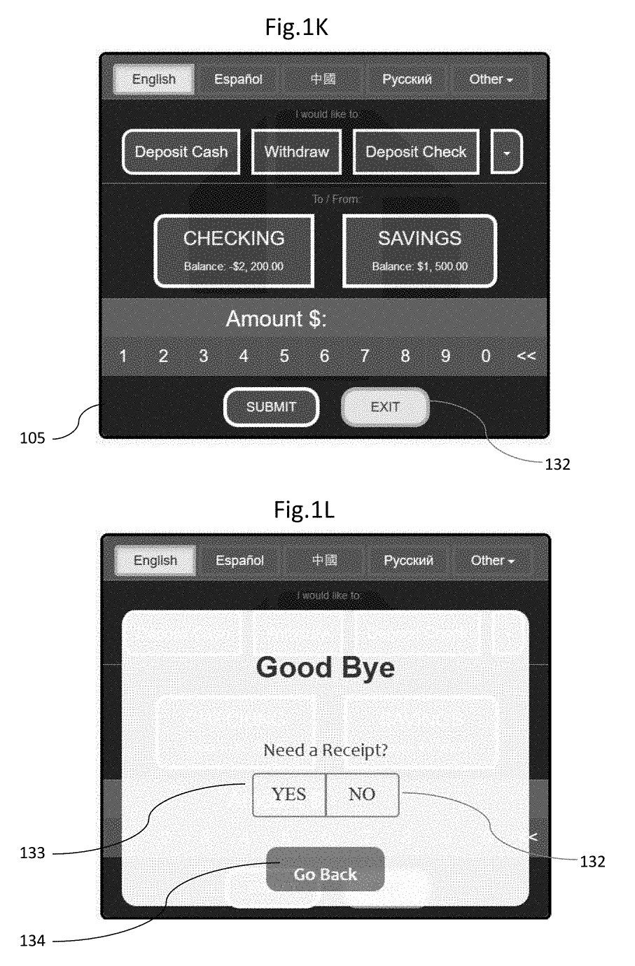

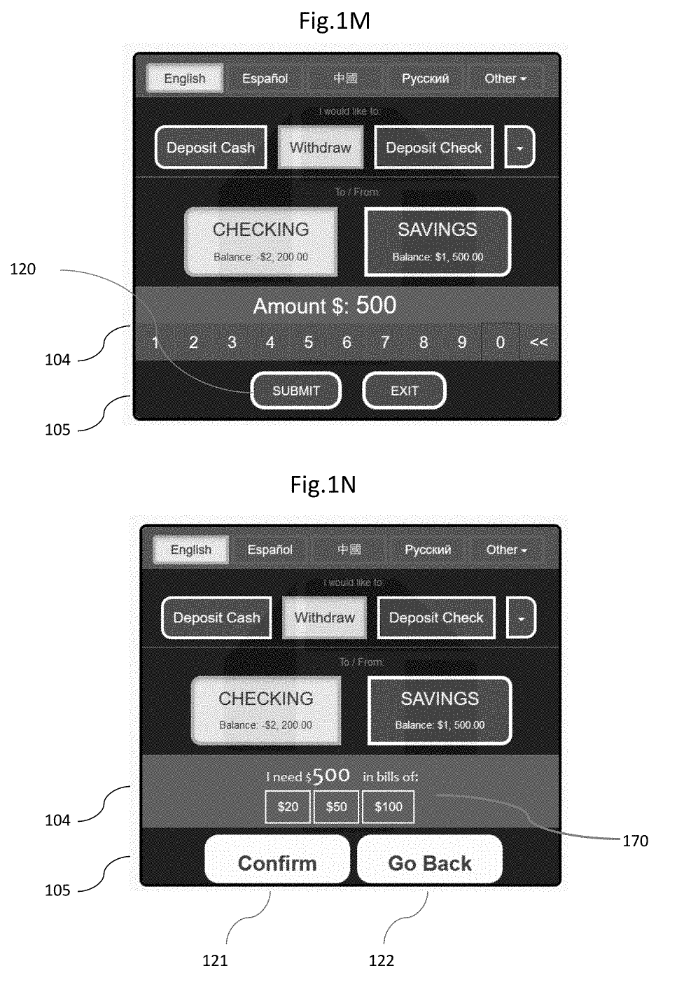

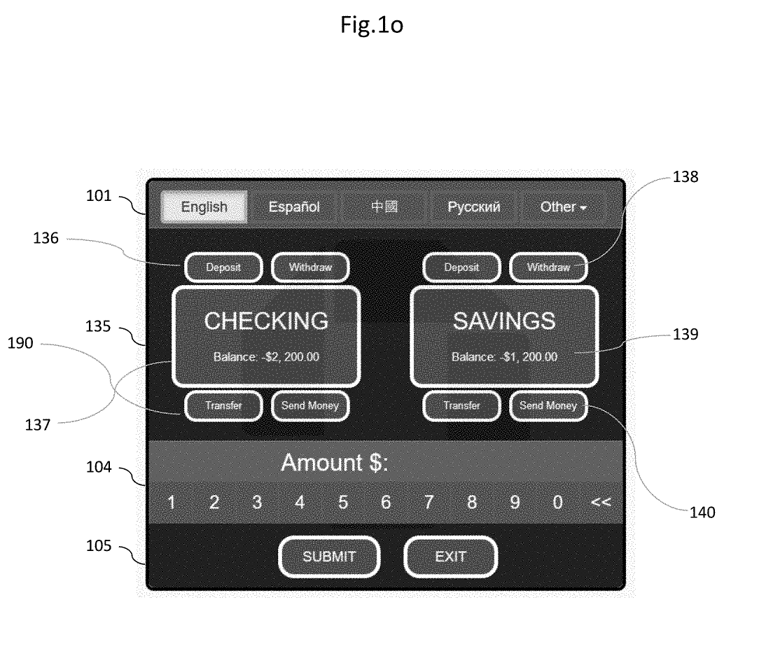

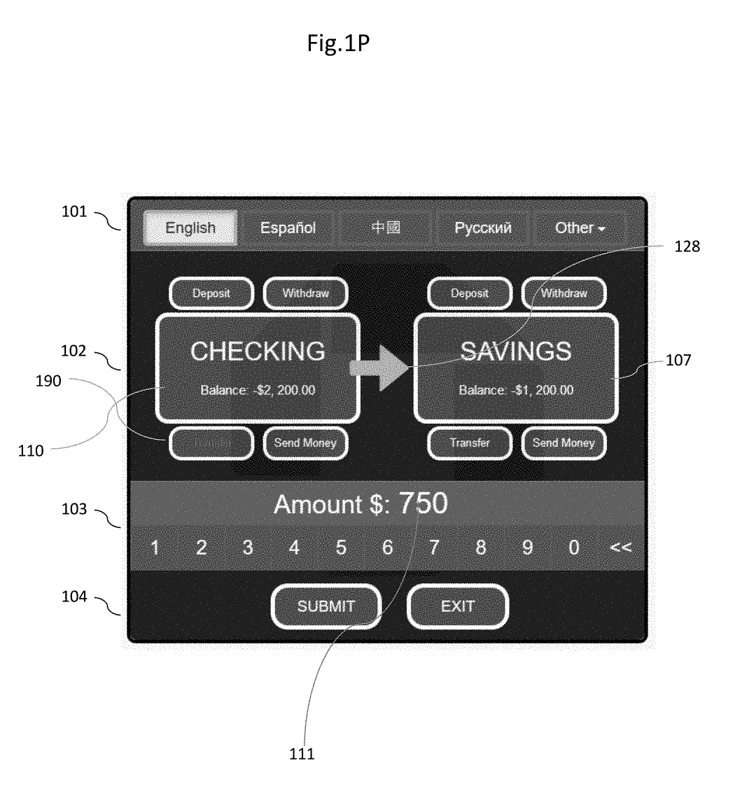

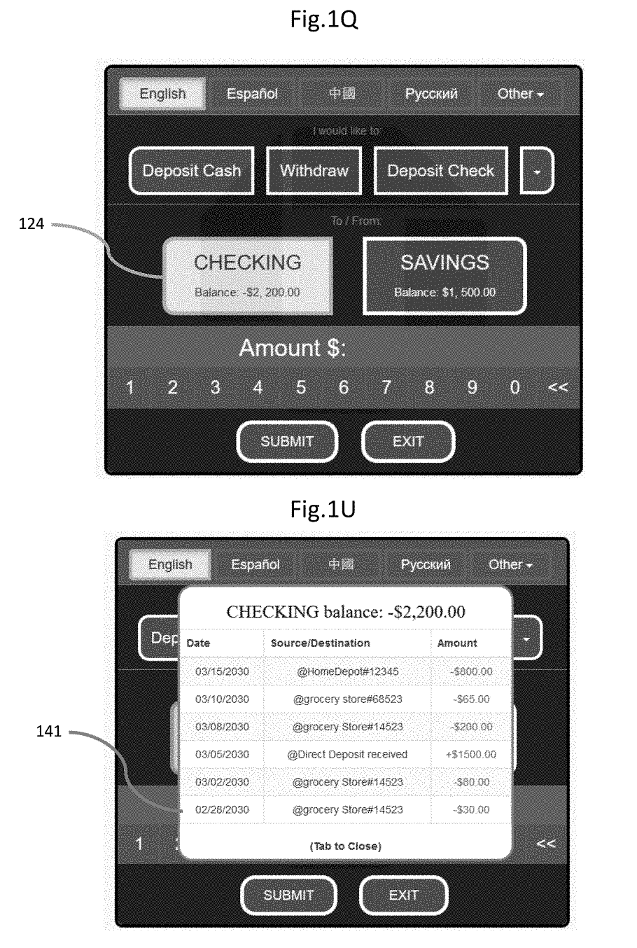

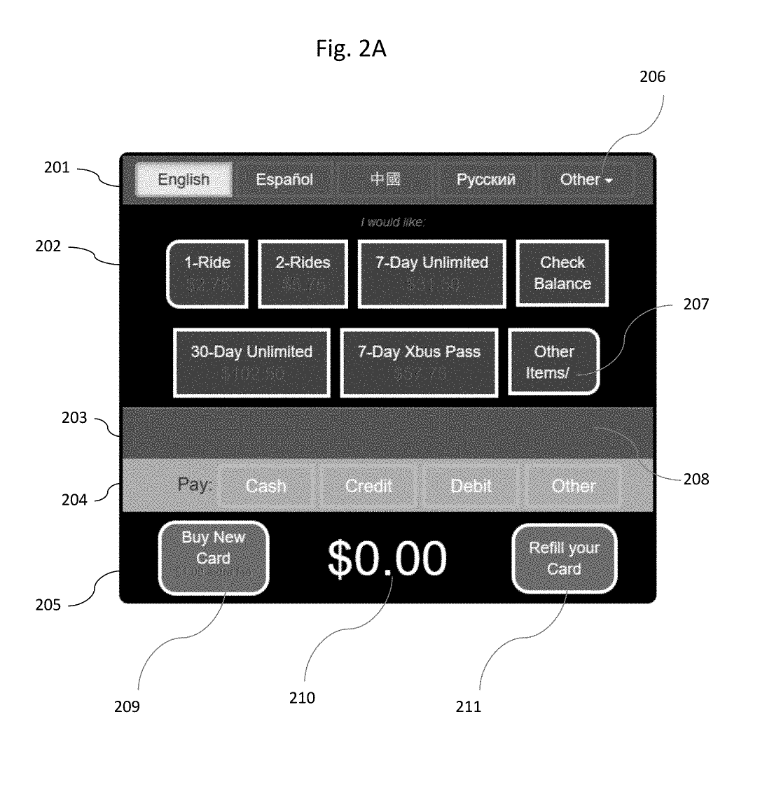

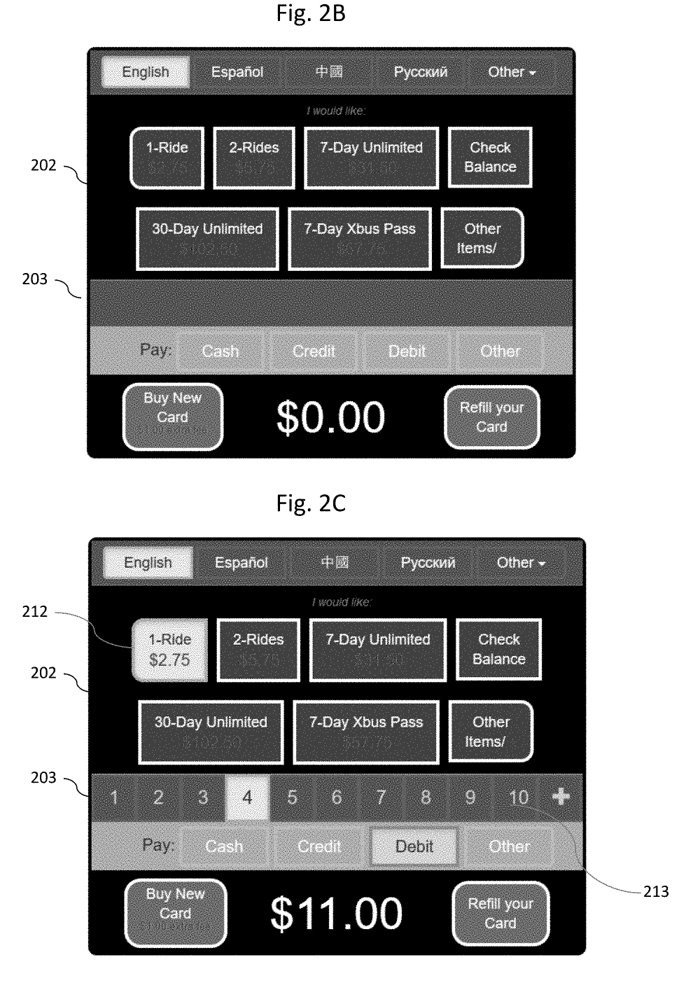

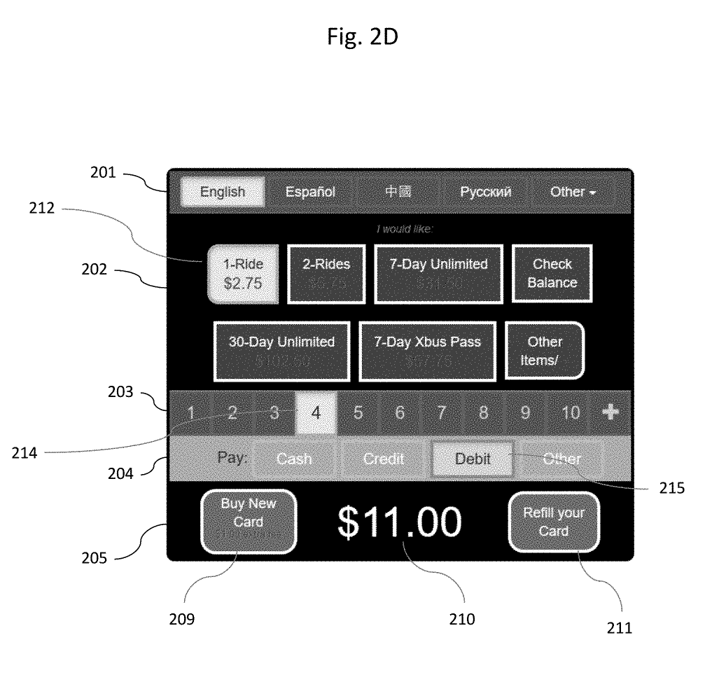

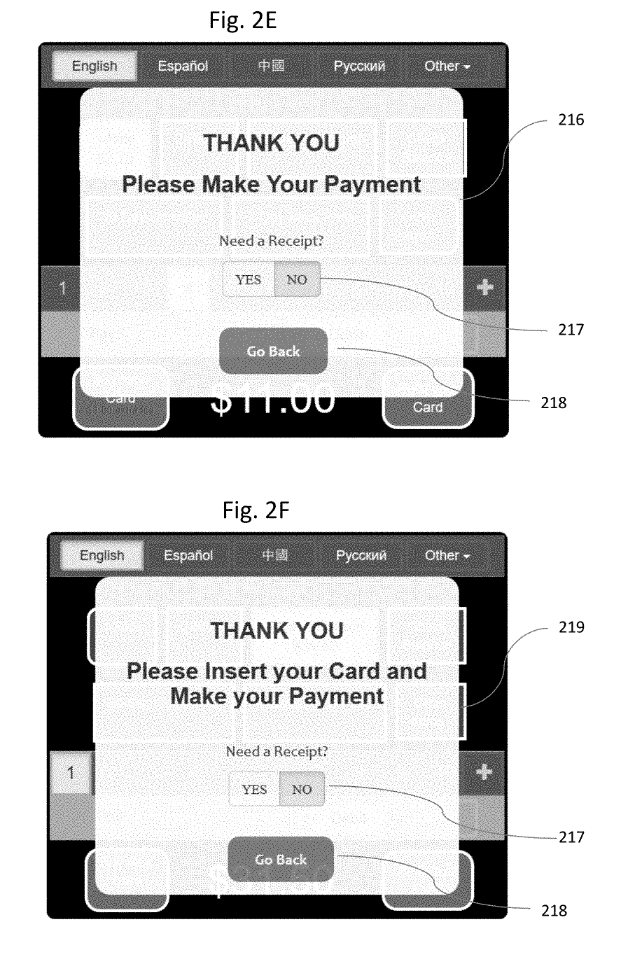

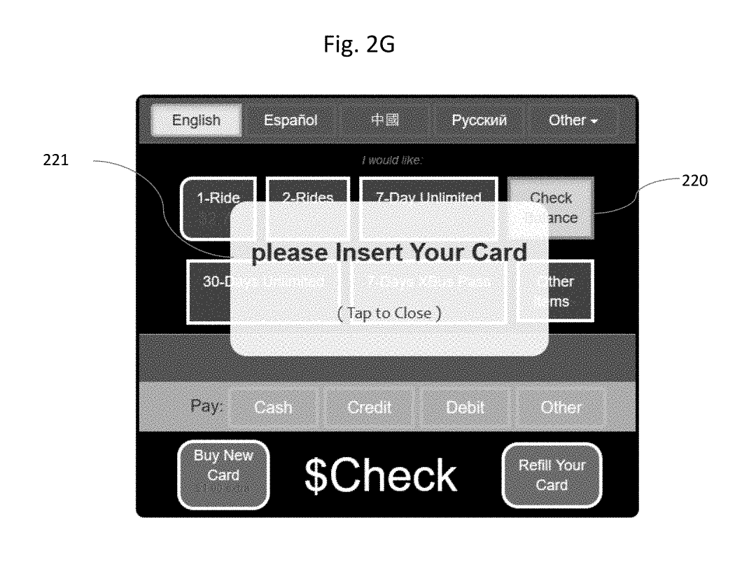

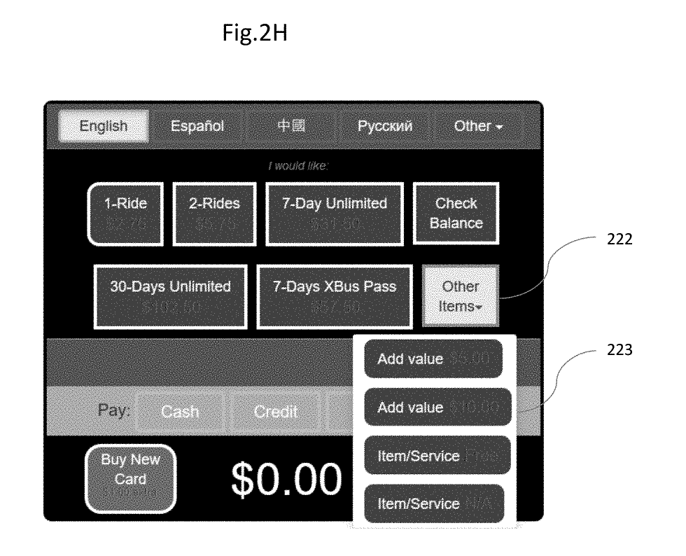

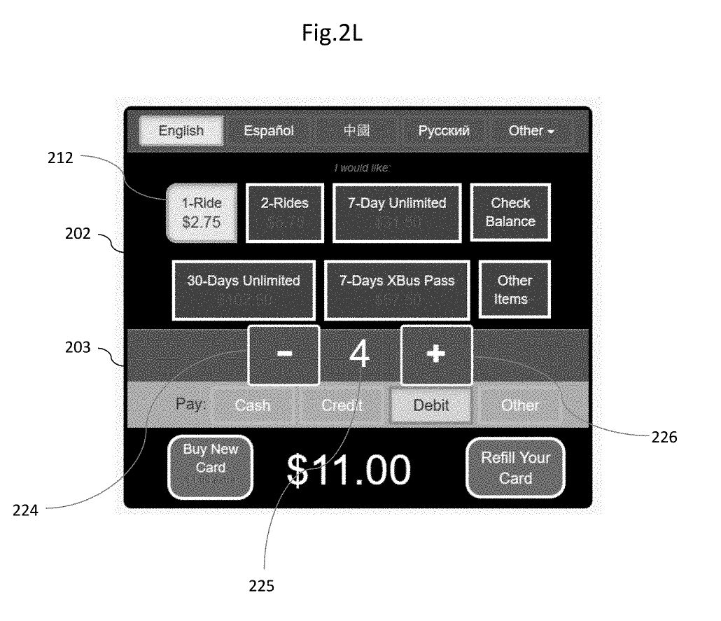

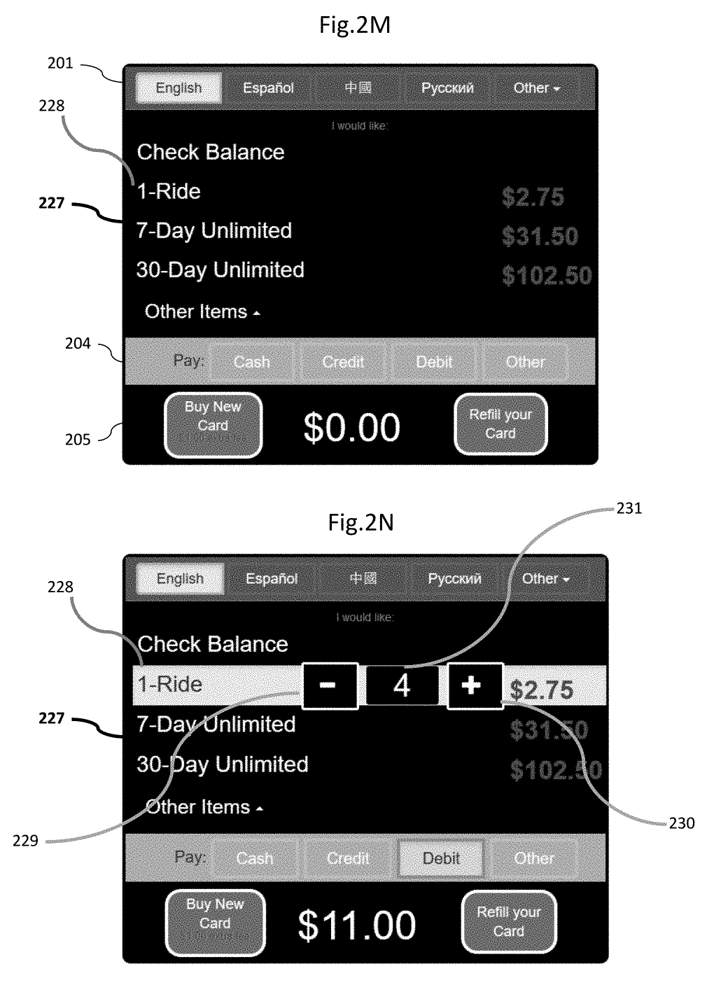

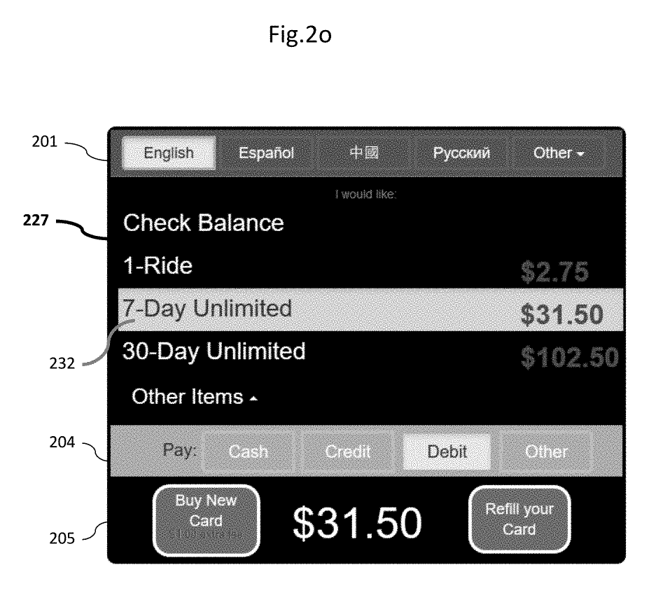

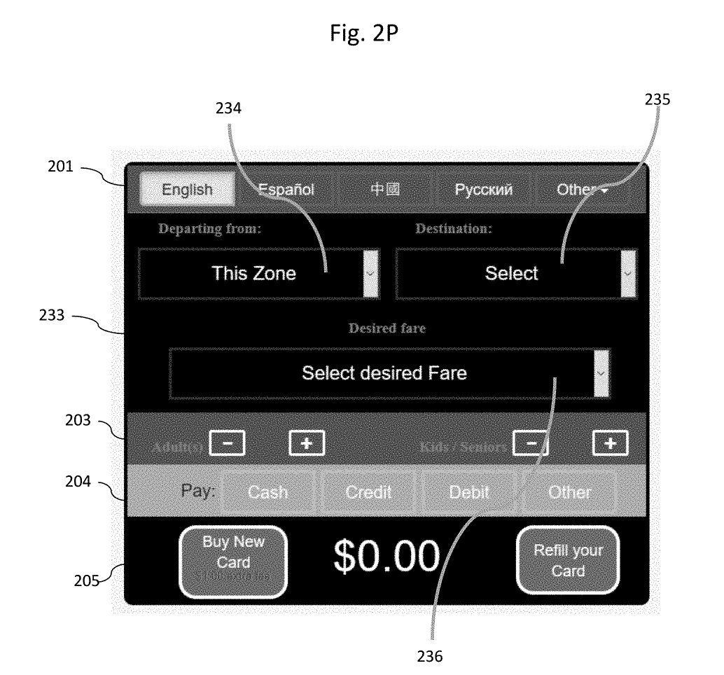

FIG. 1P illustrates a bit of the functionality and convenience of the model mentioned in FIG. 1o. The transfer option was selected by the user and an Arrow appeared pointing to the other Account's button as the destination for the transfer.

FIG. 1Q and FIG. 1U illustrate a panel displaying info about the item/service represented by a a button the user has double tapped.

FIG. 2A illustrates the mentioned UI/UX being disclosed in this IP customized to be employed at vending Machines of metro stations.

FIG. 2B and FIG. 2C illustrate options selected by the user and also how selecting an option make some content appear in a formerly empty Row.

FIG. 2D illustrates that the user has selected an option in each Row.

FIG. 2E and FIG. 2F illustrate a prompting panel requesting the user to execute an action.

FIG. 2G illustrates another prompting panel triggered by the tap of a single button, it requesting the user to execute an action.

FIG. 2H Illustrates the content of a dropdown-menu being displayed after the user tapped the dropdown-menu button. The user can select the desired option from this dropdown-menu.

FIG. 2L illustrates a Row with a new methodology for allowing the user to specify the desired quantity of a selected item/service. This methodology consist of decrement and increment buttons.

FIG. 2M illustrates the mentioned customized model for vending machines by combining 2 Rows into a single row.

FIG. 2N illustrates an item selected by the user with decrement and increment buttons the user will use to specify the desired quantity.

FIG. 2o illustrates an item, selected by the user, which does not has decrement and increment buttons to allow the user to specify a desired quantity.

FIG. 2P illustrates several dropdown menus featured in a single Row for the user to select the desired option in each dropdown-menu at that Row.

FIGS. 3A and 3B illustrates the mentioned UI/UX Concept disclosed in this IP being employed in a mobile device as if a financial institution and transportation entities were employing it in their mobile application.

### DETAILED DESCRIPTION

This IP describes a minimalist single faceted User Interface/User Experience (UI/UX) concept design for ATMs, Vending Machines and other self-service machines. This UI/UX concept does not requires the customer to progress through a series of interfaces to submit an order. All the sections necessary to submit an order are organized into Rows.

Each Row features a set of options as buttons for the customer to select the desired one in each Row, some Rows may feature a pre-selected Option. The Option selected by the customer in each Row stays Highlighted, as radio buttons, so the customer can, with a quick glance, verify his order before submitting it.

Some Rows may feature an Option(s) that acts as a drop-down menu(s), which when tapped by the user will display more options that correspond to that particular Row. Options are hidden within these drop-down menus in an effort to keep the visual aspect of this UI/UX design as minimalist as possible.

A Row might feature a Linear-number-Keypad that allows the customer to input numeric values. The ATM models described in this IP feature this linear-number-Keypad.

A Row may feature Decrement and Increment Buttons that allow the customer to specify the desired amount of a selected item/service, some of vending machine models described in this IP feature these buttons. This Row also features a numeric value that represents the value specified by the user

Some of the Vending Machine models described in this IP combine the Select Desired Item/Service section and the Specify Desired Quantity section into a Single Row to make the user experience even more minimalist by allowing the customer to Specify the Desired Quantity Right at the Selected Row.

Some Options (buttons), when double-tapped, display info about the particular Item/Service being tapped.

Some Rows may have a default pre-selected option, if this pre-selected option meets the user's needs then then user wont need to make a selection at that Row. For example in the Language section (Row) the native language of the country is the default pre-selected option. Users native the country wont need to make a selection at this Row.

Some buttons may display info relevant to the Item/service they represent, for example, in ATM machines the buttons that represent the each Account may display the current balance of each account. This feature is a novelty and very handy as it saves the customer from having to make an extra step or look somewhere else just to find out the balance of each Account. In the case of Vending Machines the buttons displays the cost of the item/service they represent, in vending machines this is not a novelty because buttons have always displayed the cost of the item/service they represent. That information may also be placed near the button.

As mentioned above, this IP describes a very unique minimalist UI/UX concept for ATMs and Vending machines. In this UI/UX concept all Sections are organized into Rows and compiled into one or more screens. Some Rows may feature a set of radio buttons as Options for the customer to select the desired one. A row may feature a numeric-keypad that allows the user to specify desired quantity. A row may feature a set of decrement and increment buttons that allows the user to specify desired quantity, this Row also features a numeric value that represents the value specified by the user.

Row features a that consist of Sections Organized into Rows each featuring a number of Options for the customer to Select the desired one. This UI/UX concept can be customized to be employed at ATM machines, vending Machines and other self-service machines.

The IP disclosed can be better understood by looking at the description and the accompanying drawings.

As mentioned above This IP discloses a minimalist UI/UX concept for ATMs and Vending Machines. In this UI/UX concept Sections are organized into Rows and compiled into a single screen. The User simply needs to select the desired option in each Row. The Selected option at each Row stays highlighted so the user can seamlessly verify the selection he has made at each Row and also seamlessly verify his order before submitting it.

This results in users submitting their orders at the machine without having to progress through a series of interfaces. The process of submitting an order at the machine begins and ends in this one screen. This UI/UX concept could also be implemented in multifaceted design of two or more screens.

The drawings illustrate several customization and methodologies that can be implemented with this UI/UX concept (Sections organized)they are examples for ATMs and Vending Machines.

FIG. 1 illustrates a customization of this UI/UX concept for automated teller machines (ATMs) and FIG. 2 illustrates a customization of this UI/UX concept for vending machines. FIG. 3 illustrates a customization of this UI/UX concept for mobile applications of financial and transportation institutions.

FIG. 1A, illustrates a model for ATM machines. each Section is organized into a particular Row 101, 102, 103, 104, 105. A Row may feature a pre-selected default Option 115 such as native language of the Country in the first Row 101.

A Row may feature a button that act a Drop Down-Menu 110, 111 that when tapped displays more relevant options to the user.

A Row may feature a Linear-number-keypad 113 to be used by the user to input desired amount or quantity. This Row may also feature a numeric value 114 that represents the amount specified by the user using the mentioned number-keypad.

Rows 101, 102, 103, 104, 105 may be of different colors so the user can seamlessly identify them also by colors. Rows may also be divide by a visible line 116.

Rows may text 117 or image that hints to the user the purpose of the Row or what to do.

An Option (Button) may illustrate information 112 related to its role such as account balances 112 in the case of ATM machines, item cost in the case of Vending machines. In vending machines it could also warn about allergies or extra fees. This information 112 could be featured on the button or near the button.

FIG. 1B illustrates the option selected by the user in each Row 115, 118, 119, 120. The Option selected by the user stays highlighted. This Radio button functionality allows to user to first: identify the option he has selected at each particular Row. Second, it allows the user to seamlessly with a quick glance verify his order before submitting it.

At some Rows 104 the user may not be required to make a selection but instead be required to specify a desired amount 114 using a linear-number-keypad 113 or other methods such as decrement and increment buttons.

Selecting a button in a particular Row could cause the content of that particular Row or another to be replaced with relevant or irrelevant content to the original content at that Row.

For example after the user select the submit button 120 in FIG. 1B, the content of the last Row 105 the was replaced with new content for the user to make a selection. In FIG. 1C the content of the last Row 105 was replaced with content prompting the user to confirm his intention to submit the order 121 or to go back to edit his order 122.

Selecting one or a combination of two or more buttons could trigger a panel prompting the user to execute an action, make an input or other. For example FIG. 1D illustrates that the user has made two selections 123 and 124.

FIG. 1E illustrates that as a result of those two selections, mentioned, a panel 125 was triggered and it is prompting the user to execute an action (s).

FIG. 1F illustrates the options 126 of a dropdown-menu button 106 being displayed after the user has tapped that button.

FIG. 1G illustrates that the user selected the Transfer option 127 from the dropdown-menu.

FIG. 1H illustrates that an arrow 128 is pointing from which account to which account the amount 114 will be transferred.

FIG. 1i illustrates that the user has selected the option Send Money 129 from the dropdown-menu 126.

FIG. 1J illustrates that as a result of selecting the Send Money option 129 from the dropdown-menu in FIG. 1i a panel was triggered and it is prompting the user to specify destination account 131 and destination routing or Bill or Ticket number 132.

As mentioned, selecting a button in a Row could trigger a Panel prompting the user to execute an action, make a selection or other. For example FIG. 1K illustrates that the user has selected the Exit button 132 at the last Row 105.

FIG. L illustrates that this action triggered a panel prompting the user to make a selection. The user can Select Yes 133 to get his receipt and leave the machine, The user can select NO 132 if he doesn't need a receipt and leave the machine and last the user has the option of Going Back 134 if he would like to do more.

Tapping a Button may result in the content of a particular Row (s) being replaced with new content for the customer to select. For example FIG. 1M Illustrates the content of the last two Rows 104, 105 before the user Taps the Submit button 120.

FIG. 1N displays the new content of the last two Rows 104, 105 after the user has tapped the Submit button. A Row 104 is prompting the user to select desired bills 170 for his withdraw (bill denomination) Another Row 105 is now prompting the user to confirm 121 his intention to submit his or to Go Back 122 and edit his order.

Some Rows (sections) may be combined into a Single Row to offer the user the convenience of selecting two Options by tapping a single button therefore saving an extra step to the user.

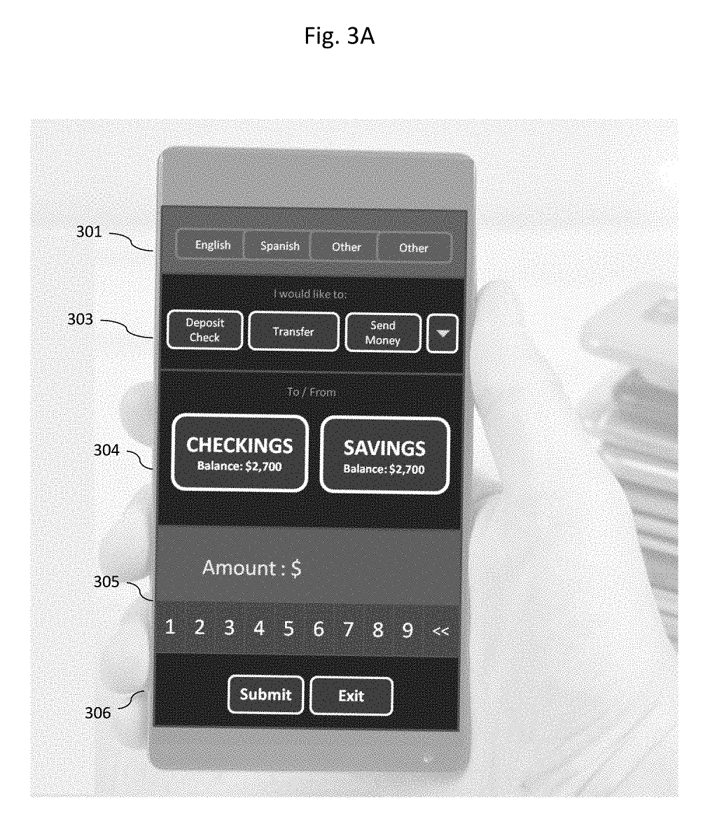

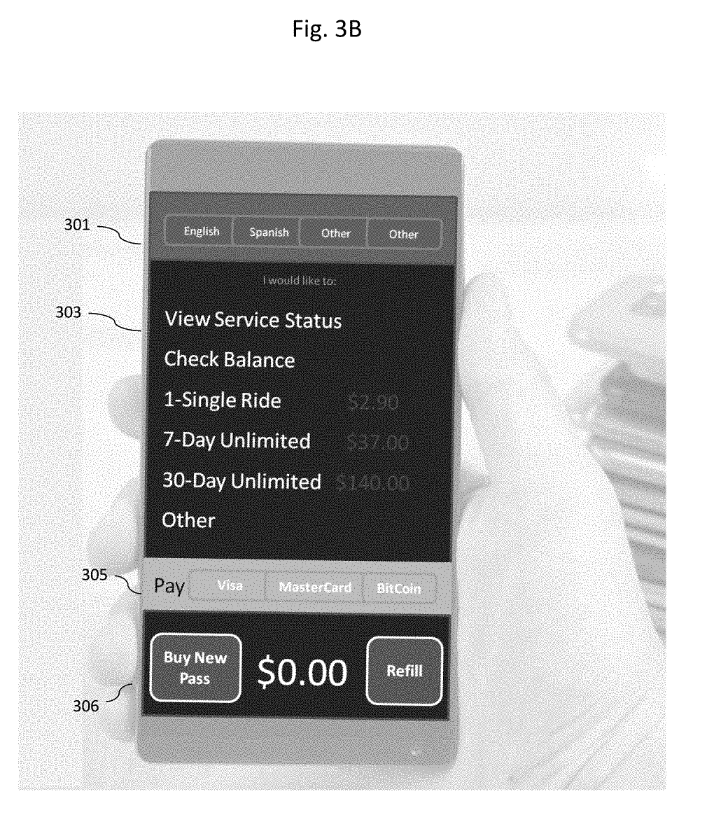

For example FIG. 10 illustrates a model where two Rows 102 and 103 in FIG. 1A were combined into a single Row 135 to save the user one step. This is more convenient for users as it will allow them to select the Desired Service and the Desired Account by pressing a single button. At this combined Row the user simply needs to tap the needed service at the desired account.

Similar to double tapping an icon or folder on a Windows PC, double taping a button with display info about the item/service that particular button is representing. For example FIG. 1Q illustrates that the user has double tapped a button 124 corresponding to the Checking Account and FIG. 1U is is illustrating a panel displaying info 141 about the Checking account. IF it was it will be displaying, for example, allergy warnings and other details about the item.

FIG. 2B illustrates that a service button Transfer 190 for an account has been selected by the user (Transfer was the service selected by the).

[symbol]

This action triggered an arrow 128 pointing from the selected Account 210 to the destination Account 207 that will be receiving the transfer. The user has also specified the amount 211 he will be transferring.

FIG. 2A illustrates the mentioned UI/UX concept customized for vending machines at metro stations. Sections are organized into Rows 201, 202, 203, 204, 205.

A Row may feature a dropdown-menu button 206, 207 which when tapped by the user displays hidden options for the user to select the desired one.

A Row 205 may feature Buttons 209, 211 and a numeric value 210 that represents the due amount. This due amount represents the value of the selected Item/service multiplied by the specified quantity.

The user will Submit his order by selecting the desired option in each Row 201, 202, 203, 204, 205. The last Row 205 features a numeric value 210 and two buttons: Buy New Card 209 and Refill your Card 211.

An empty Row 203 may display its content after the user selects an Option at another Row. For example this empty Row 203 will, after the user selects the desired item/service, will display numeric values that represent desired quantity of the selected item/service. The user specifies desired quantity by selecting one of these numeric values.

An empty Row 203 may display its content after the user selects an Option at another Row. For example this empty Row 203 will, after the user selects the desired item/service, display numeric values 213 that represent desired quantity of the selected item/service. The user specifies desired quantity by selecting one of these numeric values.

FIG. 2B illustrates empty Row 203 before the user selects his desired item/service at Row 202.

FIG. 2C illustrates Row 203 featuring numeric values 213 after the user has selected his desired item/service 212 at Row 202. 1 is the pre-selected default option of these numeric values 213.

FIG. 2D is illustrating that the user has selected the desired option 212, 214, 215 in each Row 201, 202, 203, 204, 205.

FIG. 2E illustrates a panel 216 being presented to the user after he Submitted his order using the Buy New Card button 209 in FIG. 210.

This panel is prompting the user to make his payment, this panel is also asking the user if he needs a receipt 217. The panel is also presenting the user the option to Go Back 218 to edit his order.

FIG. 2F illustrates a panel 219 being presented to the user after he Submitted his order using the Refill Card button 211 in FIG. 210. This panel is prompting the user to Insert his Card to be Refilled and also to make his payment, this panel is also asking the user if he needs a receipt 217. The panel is also presenting the user the option to Go Back 218 to edit his order.

These Panels 216, 219 like some others illustrated in the drawings feature a semi-transparent appearance to make it possible for the user to verify his order without needing to close the panel. Being Semi-transparent allows the user to verify content behind the panel.

As mentioned before in this IP, some buttons when tapped may display a panel prompting the user to execute an action, input data or it may simply display data.

FIG. 2G illustrates that a button 220 was tapped by the user and a panel 221 was immediately displayed prompting the user to execute an action. In this particular case the user taped the button 220 to Check the balance in his card and the Machine is asking the user 221 to insert his Card to Check the balance in it.

As mentioned before, Some rows may feature a dropdown-menu button that displays more options to the user when tapped.

FIG. 2H illustrates a dropdown-menu button 222 displaying several options 223 for the user to select the desired one.

FIG. 2C illustrated a methodology for allowing the user to specify his desired quantity by simply selecting the one of the desired numeric values that appeared at the third Row 203 after he selected the desired item/service.

FIG. 2L illustrates a new methodology at the third Row 203 for allowing the user to specify the desired quantity of the selected item/service using decrement 224 and increment buttons 226 to increment and decrement his desired quantity. A numeric value 225 displays to the user the quantity he has specified.

As mentioned before, two Rows (sections) may be combined into a single Row to make the experience feel and look more minimalist to the user.

For example FIG. 2M combined two Rows into a single Row 227. The user will select his desired item service and will specify the desired quantity of that desired item/service right at the item/service selected.

For example FIG. 2N illustrates that the user selected the desired item 228 and decrement 229 and increment 230 buttons that appeared on the selected item 228 to be used by the user to specify the desired quantity. A numeric value 231 displays to the user the amount he has specified.

These increment 230 and decrement 229 buttons are hidden, they are only displayed when the user selects the item/service. This is to keep visual aspect as minimalist and user friendly as possible. Some item/service may be limited to a maximum quantity of 1, therefore increment 230 and decrement 229 buttons will not appear on these items since the user don't need to specify a desired quantity at these items.

FIG. 2M also illustrates item 228 before being selected by the user. FIG. 2N illustrates item 228 after being selected by the user.

FIG. 2o illustrates a selected item 232 that does not displays the mentioned increment 230 and decrement 229 buttons since this item is limited to a maximum quantity of one.

A Row may feature one or more dropdown-menus. FIG. 2P illustrates the mentioned UI/UX concept featuring a Row 233 that features several dropdown-menus 234, 235, 236. The user will need to make a selection at each of these dropdown-menus. Some dropdown-menus may have a pre-selected default option as is the case with a particular dropdown-menu 234.

This model is convenient for users because otherwise they would have to progress through several interfaces to submit an order.

This UI/UX concept for automated teller machines (ATMs) and Vending Machines can be employed by financial entities, transportation entities and others in their mobile applications. It will be great and convenient if these entities offered, to their customers, the same self-service experience via any channel (self-service machine, mobile application, website, etc).

FIG. 3A and FIG. 3B illustrates the mentioned UI/UX concept in a mobile device. This illustration illustrates a Financial mobile application employing the UI/UX concept being disclosed in this IP. Transportation entities could also employ this UI/UX concept their mobile application.

Sections are organized into Rows 301, 302, 303, 304, 305. Each Row is featuring a set of options for the customer to select the desired one. The option selected by the customer, in each Row stays highlighted so the customer can seamlessly verify his order before submitting it. A row may feature one or more dropdown-menus that contain options for the customer to select the desired one. A row may feature a numeric-keypad or increment and decrement buttons that allows the user specify desired amount of a selected item service.

### SUMMARY

This IP describes a minimalist UI/UX concept design for ATMs, Vending Machines and other self-service machines. This is UI/UX concept does not requires the customer to progress through a series of interfaces to submit an order. This is a single faceted user interface where all the sections necessary to submit an order are organized into Rows.

Some Rows feature a set of buttons as options for the customer to select the desired one in each Row, some Rows may feature a pre-selected Option. These buttons feature radio button functionality which makes the button selected by the user stay highlighted making it easier for the user to, with a quick glance, identify the item he has selected at each row and also verify his order before submitting it. Some Rows may feature a number keypad or decrement an increment buttons which the user will use to specify the desired quantity of a selected item/service.

This IP also discloses several configurations for some rows (sections) that make this UI/UX concept suited for either ATMs or Vending Machines.

1. A single faceted or multifaceted user interface for self-service machines, such as automated teller machines (ATMs) and Vending machines, featuring its sections organized into Rows.

2. Some of said Rows of claim 1 could optionally feature a group of buttons as options for the user to select the desired one(s).

3. Some of said Rows of claim 1 could optionally feature a group of buttons as options for the user to select the desired one(s) and also feature a drop-down menu button containing more options for the user to select the desired one.

4. Said buttons of claim 2 could optionally feature Radio Button functionality or Checkbox functionality so that the button(s) selected by the user in a particular Row stays highlighted.

5. A Row of claim 1 may also feature a linear number keypad that allows the user to input a numeric value that signifies a desired quantity of a selected item/service.

6. A Row of claim 1 may also feature increment and decrement buttons that allows the user to specify a numeric value which signifies a desired quantity of a selected item/service.

7. Said Row of claims 5 and 6 should also feature a numeric value displaying the input specified by the user with the mentioned linear number keypad or with the increment and decrement buttons.

8. Said Row of claim 2 may feature a pre-selected default button.

9. A Row of claim 1 may feature a set of radio buttons each representing a numeric value for the user to select the desired one signifying the desired quantity of a selected item/service.

10. Said radio buttons of claim 9 could optionally feature a pre-selected default button.

11. A Row of claim 1 may feature one or more drop-down menus, each optionally pre-selected default option, for the user to select the desired option in each one of them.

12. Selecting one or more of the mentioned buttons in claim 2 could optionally cause a panel to be displayed to the user, this panel could be prompting the user to execute an action, make a selection, make an input or other or a combination of these.

13. Said panels of claim 12 may be semi-transparent for the purpose of allowing the user to view through them to verify his order if he needs to.

14. In ATM machines, the buttons representing each banking account could optionally display the current account's balance or could feature the account balance near them.

15. In ATM machines, selecting the Transfer button will display an arrow pointing from the source account to the destination account for the transfer and if the user selects the other account the arrow gets inverted.

16. A Row of claim 1 may feature a combination of buttons and a numeric value where this numeric value may be the desired quantity of a user selected item/service or a due amount.

17. Selecting one of the mentioned buttons in claim 2 may cause the content of one or more rows of claim 1 to get replaced with new content.

18. Selecting one of the mentioned buttons in claim 2 may cause the hidden content at one or more Rows to show.

19. Said Buttons of claim 2 maybe feature decrement and increment buttons that allows the customer to specify his desired quantity which my be displayed by a numeric value also featured by that button.

20. Double tapping one of the buttons mentioned in claim may open a panel displaying info about the item/service being represented by that particular button.

21. Mobile applications of financial, transportation and other entities could feature the mentioned single faceted or multifaceted user interface mentioned in claim 1 where sections required to submit an order are organized into rows featuring buttons for the customer to select the desired one, mentioned in claim 2, and rows featuring a plurality of methods for allowing the user to specify desired quantity of a selected item/service.

21. Said Rows of claim 1 may be colored differently from one another to make it easier for the user to distinguish them or simply to express the brand's culture.

22. A plurality of user interfaces for self-service machines could feature any of the features mentioned in claim 1, 3, 4, 5, 9, 11, 14, 15, 19.
